(19) United States
(12) Patent Application Publication
(10) Pub. No.: US 2024/0019994 A1
(43) Pub. Date: Jan. 18, 2024

(54) METHOD FOR SETTING PARAMETERS OF A TRANSFER FUNCTION

(71) Applicant: Quantonomics GmbH, Zürich (CH)

(72) Inventor: Lars B. SONDEREGGER, Zollikerberg (CH)

(21) Appl. No.: 18/037,297

(22) PCT Filed: Nov. 2, 2021
(86) PCT No.: PCT/EP2021/080392

§ 371 Date: May 16, 2023

(30) Foreign Application Priority Data
Nov. 16, 2020 (CH) 01465/20

(51) Int. Cl. G06F 3/04847; G06F 3/0481

(52) U.S. Cl. CPC G06F 3/04847; G06F 3/0481

(57) ABSTRACT

The present invention relates to a method for setting at least one parameter (P1, . . . Pn) of a transfer function which at least partially defines an input/output behavior of a system unit (4), wherein the system unit (4) with a computing unit (1) is operatively connected to an input unit (2) for setting the at least one parameter (P1, . . . , Pn). According to the invention, it is proposed that first an initial value for the at least one parameter (P1, . . . , Pn) is set with the aid of the input unit (2) and that subsequently a target value for the corresponding at least one parameter (P1, . . . , Pn) is set with the aid of the input unit (2).

The present invention relates to a method according to the preamble of claim 1.

Transfer functions describe the input/output behavior of a system in a mathematical way. In general form, it is a quotient with two polynomials, each of which has its own parameters. The degree of the polynomials determines the number of parameters and thus the complexity of the system to be described.

Changing the parameters of such a transfer function has a significant influence on the overall behavior of the system. In this context, it is not uncommon that initial values for the parameters are known or can at least be estimated. Furthermore, it is often desired to optimize the transfer function. Accordingly, target values for the parameters are specified or optimal target values for the parameters are searched for an optimal overall system behavior.

The present invention is based on the object of providing a method that enables simple acquisition of initial values and/or target values of parameters.

This object is solved by the measures indicated in the characterizing part of claim 1. Advantageous embodiments of the invention are indicated in further claims.

A method for setting at least one parameter of a transfer function is given which at least partially defines an input/output behavior of a system unit, wherein the system unit is operatively connected to a computing unit with an input unit for setting the at least one parameter. The method according to the invention is characterized in that first an output value for the at least one parameter is set with the aid of the input unit and that subsequently a target value for the corresponding at least one parameter is set with the aid of the input unit.

One embodiment of the method according to the invention is that the input unit comprises a touch-sensitive screen or that the input unit comprises a screen with a pointing device operatively connected thereto, wherein in one operating state of the screen the screen displays a cursor which reflects a position of the pointing device.

Further embodiments of the method according to the invention consist in setting initial values and target values for each parameter via a single slide control.

Further embodiments of the method according to the invention consist in the fact that initial values and target values for each parameter are each set via a slide control, with each of the slide controls being graphically displayed individually on the input unit.

Further embodiments of the method according to the invention consist in that one control element of the slide control is shifted to the initial value of the respective parameter and that subsequently the control element of the same slide control of the respective parameter is shifted to the target value.

Further embodiments of the method according to the invention consist in the fact that only the initial values being possible for a parameter and only the target values being possible for a parameter can be set with the control element.

Further embodiments of the method according to the invention consist in displaying the initial value on the input unit after it has been determined.

Further embodiments of the method according to the invention consist in displaying the target value on the input unit after it has been determined.

Further embodiments of the method according to the invention consist in graphically displaying the initial value and the target value of a parameter within the slide control.

It is noted that the above embodiments of the present invention may be combined in any desired manner. Only those embodiments which would lead to contradictions by a combination are excluded.

The present invention is explained in more detail below with reference to drawings illustrating embodiments. Thereby show:

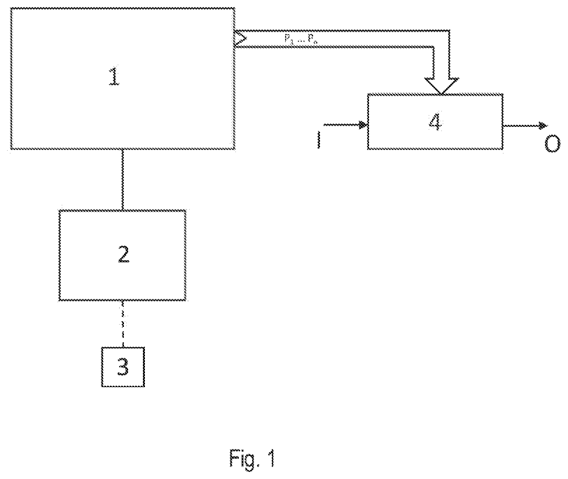

FIG. 1 a simplified block diagram showing the essential components for carrying out the process according to the invention, and

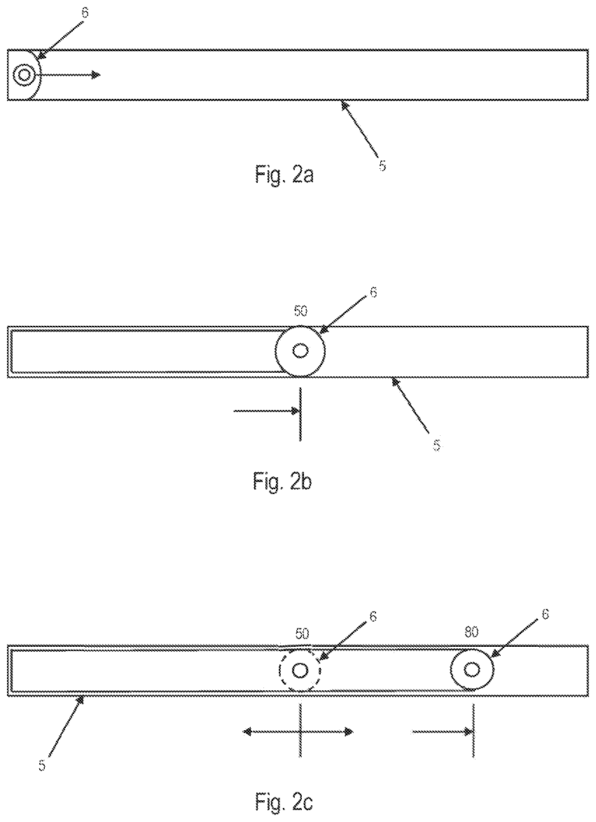

FIG. 2 a slide control according to the invention for setting at least one parameter of a transfer function.

FIG. 1 shows a computing unit 1 to which an input unit 2 is operatively connected. The input unit 2 is, for example, a touch-sensitive screen via which information such as parameters or the like can be entered into the computing unit 1 via graphical elements—such as, for example, a slide control to be explained. Alternatively, the input unit 2 consists of a screen—be it touch-sensitive or contactless—which is operatively connected to a pointing device 3. The pointing device 3 can be a computer mouse or the like, with the help of which the position of a cursor displayed on the screen can be determined and thus also graphic elements for inputting information to the computing unit 1 can be controlled or defined.

The information defined via the input unit 2 and the computing unit 1 is used to define an input/output behavior of a system unit 4. For this purpose, the computing unit 1 is operatively connected to the system unit 4. Values for parameters P₁, . . . , Pₙ, which are entered into the computing unit 1 via a graphical user interface of the input unit 2 to be explained, are transmitted via the operative connection between computing unit 1 and system unit 4. The values for the parameters P₁, . . . , Pₙ define the input/output behavior of the system unit 4. In this context, one also speaks of a transfer function between the input I and the output O.

Commercially available products can be used for the computing unit 1, the input unit 2 and for the pointing device 3. For the computing unit 1 these can be so-called PCs, for the input unit 2 these can be touch-sensitive screens and for the pointing device 3 these can be a computer mouse.

FIG. 2 shows various slide controls 5 according to the invention for setting at least one parameter P₁, . . . , Pₙ for at least partial definition of the transfer function between the input I and the output O. The slide control 5 according to FIG. 2 is provided with a control element 6 which takes different positions in the slide control 5 and reproduces the sequence of the definition of the respective parameter to be set:

Thus, FIG. 2a shows the initial position in which the control element 6 is located at the left edge of the slide control 5. The initial position is assumed as the basic setting when a parameter P₁, . . . , Pₙ is set. Of course, the control element 6 can take any position within the slide control as the initial position.

In the present setting of the parameters P₁, . . . , Pₙ according to the invention, it is assumed that each parameter has an initial value and a target value, whereby the initial value is not necessarily set in the initial position according to FIG. 2a. Rather, it is assumed that the control element 6—as shown according to FIG. 2b—is shifted from the initial position to the initial value of the respective parameter P₁, . . . , Pₙ. For this purpose, the control element 6 is pushed to the initial value with a finger of the user. The prerequisite here is the use of a touch-sensitive screen as input unit 2 (FIG. 1). Alternatively, the control element 6 can also be moved to the desired position within the slide control 5 using a pointing device 3. This position is read in by the computing unit 1 and stored as the initial value for the respective parameter P₁, . . . , Pₙ.

Finally, according to FIG. 2c, the control element 6 is moved from the position of the initial value for the respective parameter P₁, . . . , Pₙ to the position of the target value in the slide control 5. This position is again stored as the target value for the respective parameter P₁, . . . , Pₙ in the computing unit 1 after confirmation, which can be performed, for example, by a click with the pointing device 3.

In the case of several parameters P₁, . . . , Pₙ—expressed here by the index n—it is provided in one embodiment that only one slide control 5 is displayed on the input unit 2 and that all n parameters P₁, . . . , Pₙ are set in sequence with the same slide control 5. In another embodiment, all n—or at least several—slide controls 5 are displayed on the input unit 2 and the values for the parameters P₁, . . . , Pₙ are then set on the various slide controls 5.

Furthermore, in further embodiments of the present invention, it is provided that the numerical value corresponding to the position of the control element 6 is displayed in proximity to the slide control 6 to provide direct feedback to the user about the value.

In a further embodiment of the present invention, it is provided that the control element 6 of the slide control 5 can only be set in a range in which values lie that are permissible at all for the respective parameter P₁, . . . , Pₙ. Accordingly, the impermissible value ranges for the respective parameter P₁, . . . , Pₙ are blocked in the slide control 5 for the control element 6.

1. Method for setting at least one parameter (P₁, . . . , Pₙ) of a transfer function which at least partially defines an input/output behavior of a system unit (4), the system unit (4) being operatively connected to a computing unit (1) having an input unit (2) for setting the at least one parameter (P₁, . . . , Pₙ), characterized in that, first, an output value for the at least one parameter (P₁, . . . , Pₙ) is set with the aid of the input unit (2) and that, subsequently, a target value for the corresponding at least one parameter (P₁, . . . , Pₙ) is set with the aid of the input unit (2).

2. Method according to claim 1, characterized in that the input unit (2) comprises a touch-sensitive screen or in that the input unit (2) comprises a screen with a pointing device (3) operatively connected thereto, wherein in one operating state of the screen the latter depicts a cursor which reflects a position of the pointing device (3).

3. Method according to claim 1, characterized in that output values and target values for each parameter (P₁, . . . , Pₙ) are set via a single slide control (5).

4. Method according to claim 1, characterized in that output values and target values for each parameter (P₁, . . . , Pₙ) are each set via a slide control (5), each of the slide controls (5) being graphically displayed individually on the input unit (2).

5. Method according to claim 3, characterized in that a control element (6) of the slide control (5) is shifted to the initial value of the respective parameter (P₁, . . . , Pₙ) and that subsequently the control element (6) of the same slide control (5) of the respective parameter (P₁, . . . , Pₙ) is shifted to the target value.

6. Method according to claim 5, characterized in that only the output values being possible for a parameter (P₁, . . . , Pₙ) and only the target values being possible for a parameter (P₁, . . . , Pₙ) can be set with the control element (6).

7. Method according to claim 1, characterized in that the initial value is displayed on the input unit (2) after it has been determined.

8. Method according to claim 1, characterized in that the target value is displayed on the input unit (2) after it has been defined.

9. Method according to claim 4, characterized in that the initial value and the target value of a parameter (P₁, . . . , Pₙ) are displayed graphically within the slide control (5).
